(19) United States
(12) Patent Application Publication
(10) Pub. No.: US 2004/0004395 A1
(43) Pub. Date: Jan. 8, 2004

(54) Endless track for a vehicle

(76) Inventors: Gilles Soucy, Drummondville (CA); Yves St-Pierre, Wickham (CA); Andre Deland, Drummondville (CA); Claude Faucher, Drummondville (CA)

Correspondence Address: Robert Brouillette, BROUILLETT KOSIE PRINCE, 25th Floor, 1100 Rene-Levesque Boulevard West, Montreal, QC, H3B 5C9, CA

(21) Appl. No.: 10/414,557

(22) Filed: Apr. 15, 2003

Related U.S. Application Data
(63) Continuation-in-part of application No. 09/954,168, filed on Sep. 18, 2001, now abandoned.

(30) Foreign Application Priority Data
Sep. 18, 2000 (CA) 2,319,937

(51) Int. Cl. B62D 55/24

(52) U.S. Cl. 305/178

(57) ABSTRACT

The endless track is made of a reinforced rubber material with longitudinally spaced and transversely disposed ridges or lugs. It is particularly well-adapted for recreational snowmobiles having a single track. The, ground-engaging side of the track features a tread pattern that is repeated uniformly or not over the entire length of the track. The tread pattern comprises a plurality of projecting traction lugs each an upper edge having which together delimit the general outline of a cross-sectional transversal traction lug profile when viewed along a longitudinal direction. The track is characterized in that the traction lug profile comprises a substantially flat central or interior section and two opposite exterior or lateral sections located on the sides of the interior section and that taper toward the exterior. Such track facilitates the steering capabilities of a snowmobile, particularly when the snowmobile is traveling on hard and abrasive surfaces. It also improves the durability of the track.

This is a continuation in part of application Ser. No. 09/954,168 filed on Sept. 18, 2001.

### FIELD OF INVENTION

The present invention relates to an endless track for a vehicle. More particularly, the present invention relates to a track which is particularly well suited for a vehicle having a single track, such as a conventional recreational snowmobile.

### BACKGROUND OF THE INVENTION

A track is found on off-road vehicles which are designed to travel on grounds that could not adequately support wheels or on which traction forces could not be suitably applied with the use of wheels. A track consists essentially of an endless band of a reinforced molded rubber material or an assembly of interconnected parts that form an endless band. The endless band is flexible around a transversal axis so that it can follow the curvature around drive and idler sprocket wheels. Each track is designed to support a portion of the weight of the vehicle and apply a traction force on the ground.

Among all off-road vehicles equipped with tracks, recreational snowmobiles are unique in that they are equipped with only one track, while essentially all other vehicles are equipped with two or more tracks. Examples of such other vehicles are bulldozers, military tanks, snow-surfacing machines, etc. Tracks for vehicles with a single track, which are essentially snowmobiles, are the prime interest of the present invention.

A snowmobile is often equipped with a rubber-band track that features an endless body made of a reinforced rubber material with longitudinally spaced and transversely disposed stiffeners embedded in the rubber material. The body defines a longitudinally extending central portion and a pair of lateral band portions each of which is located on one of the sides of the central portion. The track is positioned under the chassis of the snowmobile and supports most of the weight. A pair of front ski-like runners are provided to steer the snowmobile and support the other portion of the weight.

The body of the track has a ground-engaging outer side and an inner side. The inner side cooperates with a suspension system which support the weight of the track, and either consist in a pair of slide rails or a plurality of bogey wheels that are mechanically connected to the other parts of the suspension system. The suspension system is also used to support the track with respect to lateral movements.

The ground-engaging outer side has a tread pattern that is repeated uniformly or not over the entire length of the track. The tread pattern comprises a plurality of projecting traction lugs that are configured and disposed in accordance with the purpose for which the track is designed. The traction lugs are used to increase the adherence of the snowmobile on snow mud, melting snow, ice or any other similar surfaces.

Further, the opposite lateral band portions are separated from the central portion by a corresponding row of holes. Each row of holes generally cooperates with the teeth of a corresponding pair of drive and idler sprocket wheels. Alternatively, the drive and idler sprocket wheels may engage driving lugs that are inwardly projecting from the inner side of the track.

The outlines of the upper edge of adjacent traction lugs form what is referred to as a “traction lug profile” when they are viewed along the longitudinal axis of the track. The traction lug profile could be defined as the closest imaginary transversal line to the track under which all traction lugs can fit without touching it. The traction lug profile is clearly visible on a track by looking at the rear of a snowmobile or by looking at a transversal cross-sectional view of the track.

Formerly, the traction lug profile of a typical track had a shape which is somewhat flat in average. This means that the traction lugs on the sides of the track have about the same height than the traction lugs at the center thereof. This leads to a number of drawbacks.

One of them is that a snowmobile is not easy to turn on hard surfaces, especially hard surfaces with which the track has an important friction level. When turning the snowmobile on such surfaces, the traction lugs of the sides of the track are subjected to an intense abrasion and to substantial stress concentrations due to the bending. Yet, the higher the traction lugs are, the greater is the tendency of a snowmobile to go straight ahead when torque is applied to the track. This phenomenon is particularly apparent on tracks which have high traction lugs for improving the traction on powdery or otherwise light snow-covered surfaces.

Another drawback is that the outermost portions of the traction lugs near to sides of the track are subjected to premature wear. Moreover, this creates unpleasant driving situations to the driver.

The steering capabilities of a snowmobile can also be improved in the situation where the driver wants to turn or follow a curved path by offsetting his/her weight on the side of the snowmobile. This movement of mass induces forces which allow the track to bend slightly, along a longitudinal axis, as the center of mass position of the driver/snowmobile is shifted, closer to the ground and to the center of rotation of the curved path. However, considering the weight of some snowmobiles on the market and the fact that some drivers are not heavy enough or are not interested in or capable of performing such movements, there is a need for an improved track which facilitates the steering capabilities of a snowmobile when it turns or follows a curved path.

There is a similar need for a track which reduces the risks of having a premature wear of the traction lugs located on the sides of the track.

### SUMMARY OF THE INVENTION

One aspect of the present invention is to facilitate the steering capabilities of a snowmobile, particularly when the snowmobile is traveling on a hard surface, by reducing the interferences from the traction lug located on the sides of the track while still having a tread pattern which can have highly projecting traction lugs in the center thereof.

It has been found that providing a traction lug profile with two tapered sides leads to a track with a longitudinal rotational capacity [point] that facilitates the steering of the snowmobile and improves its durability.

The improved track with two tapered sides facilitates the steering capacities of a snowmobile when it is turning or following a curved path. The driver can more easily lean on the side when turning which usually results in a faster turning capacity by still providing the same stable turning conditions which is expected from such a track.

There is therefore provided an endless track for a vehicle, said track having an endless body being defined by a pair of opposite lateral edges which delimit a body width of said track, by a ground-engaging outer side and by an inner side, said ground-engaging outer side having a tread pattern comprising a plurality of projecting traction lugs having an upper edge which, when viewed along a longitudinal direction, together delimit the outline of a cross-sectional transversal traction lug profile projected above said body, said transversal traction lug profile comprising:

a central section, having a central width, and

two opposite lateral sections, each located on one side of said central section, wherein said lateral sections taper from said central section towards said lateral edges of said body and said central width varies from ⅓ to ⅔ of said body width.

There is furthermore provided an endless track for a vehicle, the track having an endless body made of a reinforced rubber material, said body defining a pair of lateral edges, a longitudinally extending central band portion, two support band portions located on each side of and next to said central band portion and two lateral band portions located on each side of said central band portion and next to said support portions, the said body having a ground-engaging outer side and an inner side, the said ground-engaging outer side having a substantially flat core portion and a tread pattern being repeated uniformly or not over the entire length of the track, the said tread pattern comprising a plurality of projecting traction lugs each having an upper edge which together delimit the outline of a cross-sectional transversal traction lug profile which is raised above said flat core portion when viewed along a longitudinal direction, the said transversal traction lug profile comprising:

a substantially flat central section having a first side and a second side,

a first lateral section adjacent said first side of the said flat central section, and

a second lateral section adjacent said second side of the said flat central section, wherein the portion of the traction lug profile formed by each of said first and second lateral sections tapers towards said flat core portion as it extends from said flat central section towards said lateral edges such that the steering capabilities of said vehicle are enhanced.

These and other aspects and advantages of the present invention are described in or apparent from the following detailed description of a preferred embodiment made in conjunction which the apparent figures.

### BRIEF DESCRIPTION OF THE FIGURES

FIG. 1 is a plan view of an example of a track according to a preferred embodiment of the present invention.

FIG. 2 is another plan view of a track according to a preferred embodiment of the present invention.

FIG. 3 is a transversal cross-sectional view taken from line A-A in FIG. 2.

FIG. 4 is a longitudinal rear view of a track mounted on a snowmobile, from the prior art.

FIG. 5 is a longitudinal rear view of the track shown in FIG. 1 when mounted on a snowmobile.

FIG. 6 is a longitudinal view showing the traction lug profile of the track shown in FIG. 1.

FIG. 7 is a transversal cross-sectional view taken from line A-A in FIG. 2.

FIG. 8 is another longitudinal view showing the traction lug profile of the track shown in FIG. 1.

FIG. 9 is another longitudinal view showing the traction lug profile of the track shown in FIG. 1.

### DETAILED DESCRIPTION OF A PREFERRED EMBODIMENT

A track (10) according to a possible and preferred embodiment of the present invention is described hereinafter and illustrated in the appended figures.

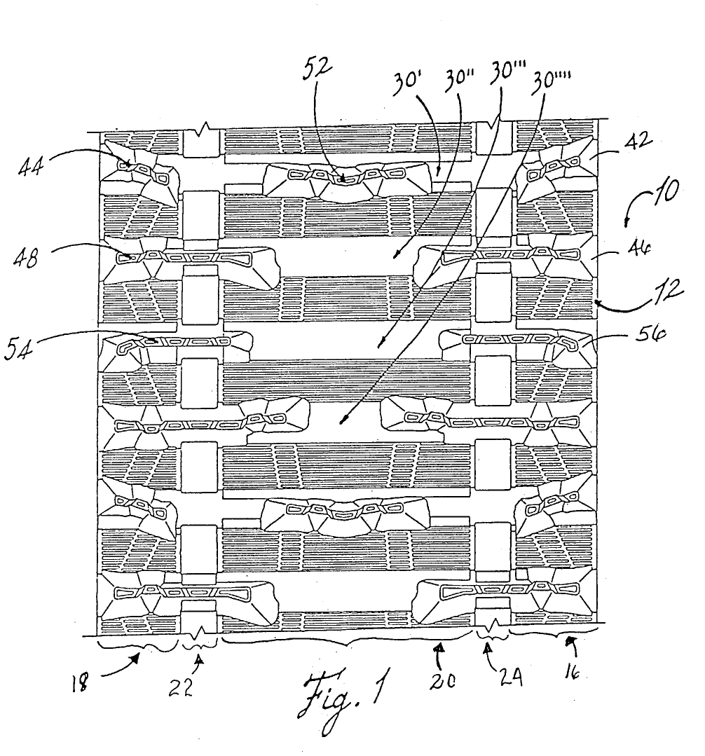

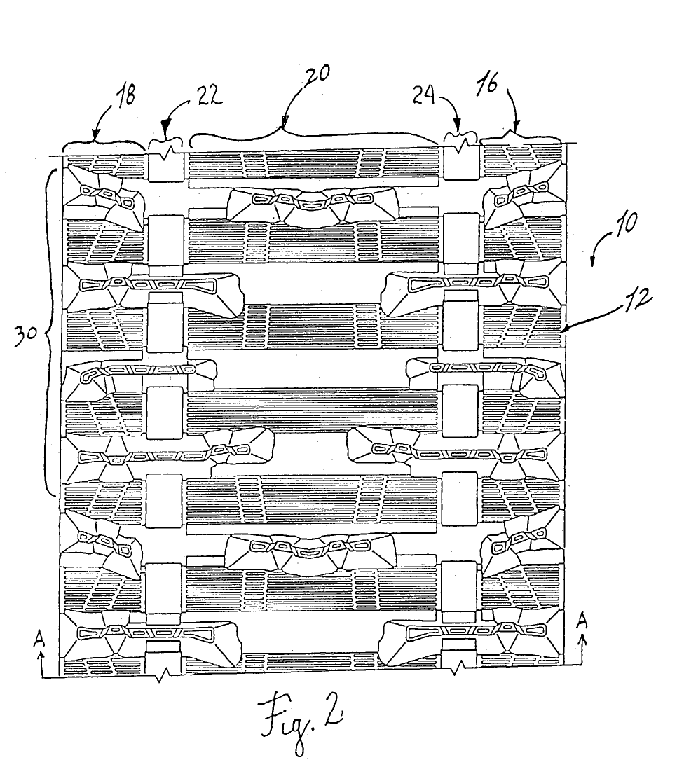

As shown in FIGS. 1, 2 and 3, the track comprises an endless body (12) made of a reinforced rubber material with longitudinally spaced and transversely disposed stiffeners (not shown) which may or may not be embedded in the rubber material. The body (12) defines a longitudinally extending central portion (20) and two lateral band portions (16, 18) located on each side of the central portion (20). The central band portion (20) is separated from each lateral band portion (16, 18) by a support portion (22, 24). Depending on the track (10) configuration, the support portions (22, 24) can comprise a succession of holes in rows along the circumference of the track (10) or may consist in a track (10) portion which acts as a support for and cooperates with the snowmobile's plurality of wheels (not shown).

The body (12) of the track (10) has lateral sides (72, 74), an inner side (80) and a ground-engaging outer side (70) that is provided with a tread pattern (30). The tread pattern (30) is repeated uniformly or not over the entire length of the track (10). The tread pattern (30) comprises a plurality of projecting traction lugs (42, 44, 46, 48, 52, 54, 56) disposed on the central band portion (20), on the lateral band portions (16, 18), on the support portions (22, 24), or on any combination of the portions (16, 18, 20, 22, 24). The traction lugs typically have between ¾ and 3 inches in lateral length. The width of the central band portion (20) is typically in the range of 5 to 10 inches, with a preferred value of 6½ inches when the total width of the track (10) is 15 inches.

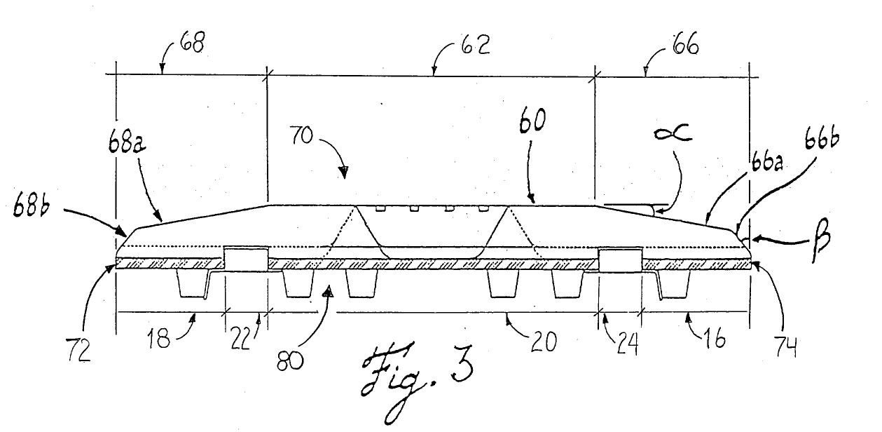

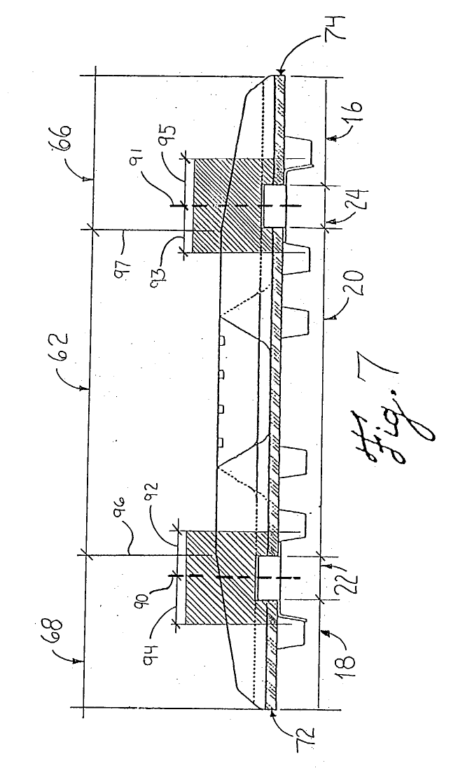

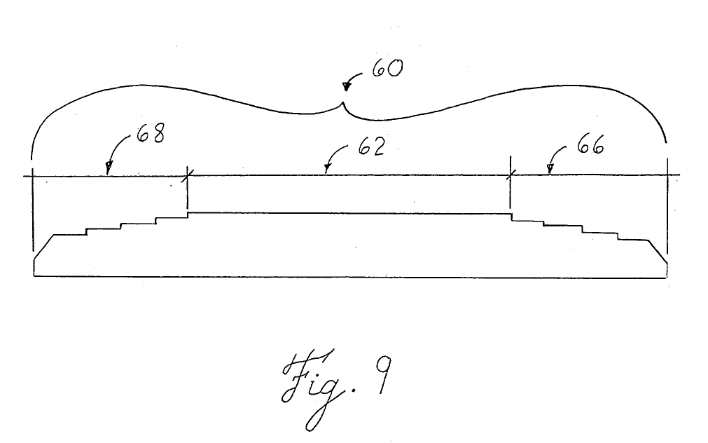

Each of the traction lugs (42, 44, 46, 48, 52, 54, 56) has an upper edge that together delimit the general outline of a cross-sectional transversal traction lug profile (60), when viewed along the longitudinal axis of the track. The expression “general outline” refers to the average laterally extending line formed by the upper edges of the lugs, which are often provided with small regular or jagged indentations. This traction lug profile (60) is shown in FIG. 3 and 6. Now, in accordance with the present invention, the track (10) is characterized in that the traction lug profile (60) comprises a substantially flat interior or central section (62) and two opposite exterior or lateral sections (66, 68) located on each side of the interior section (62) and which tapers toward the exterior. The exterior sections (66, 68) are preferably straight and symmetrical with reference to a medial axis of the interior section (62). Alternatively, the exterior sections (66, 68) are curved or taper in steps and are symmetrical with reference to the medial axis of the interior section (62), as illustrated in FIG. 8 and 9.

Preferably, the exterior sections (66, 68) have an average angle a in the range of 10 to 40 degrees with reference to the interior section (62). Further, the interior section (62) has a width that is somewhat equal to that of the central band portion (20).

Preferably, each of the exterior sections (66, 68) comprises an innermost main subsection (66a, 68a) having an average angle α in the range of 10 to 40 degrees with reference to the outline of the interior section (62), and an outermost tip subsection (66b, 68b) having an average angle β in the range of 40 to 80 degrees with reference to the lateral edges (72, 74) of the body (12).

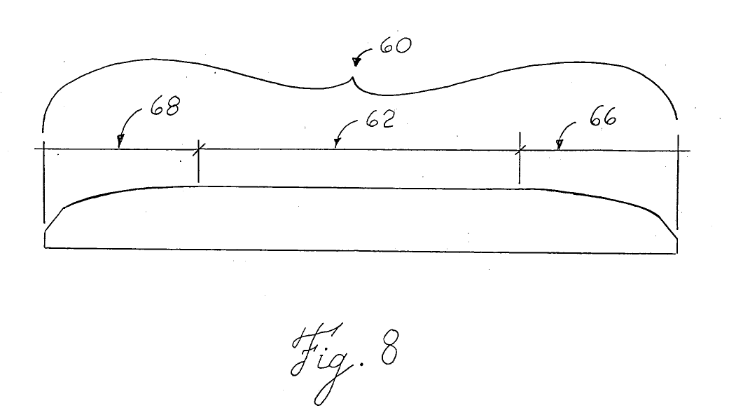

It should be noted that when designing a track (10) in accordance with the present invention, it is important to have a sufficient angular demarcation between the interior section (62) and the exterior sections (66, 68). Secondly, each exterior sections (66, 68) need to have a lateral width that is large enough to allow the tapering effect, from the interior section (62) to each lateral sides (72, 74), to be significant. As seen in FIG. 7, the lateral width of each exterior section (66, 68) is delimited by the lateral sides (72, 74) and by an interior limit (96, 97). The interior limit (96, 97) is preferably located at the same lateral position as the medial axis (90, 91) of the support portion (22, 24), but can be contained in lateral zones (92 and 94, 93 and 95) which preferably vary 1 inch in lateral distance on each side of the medial axis (90, 91).

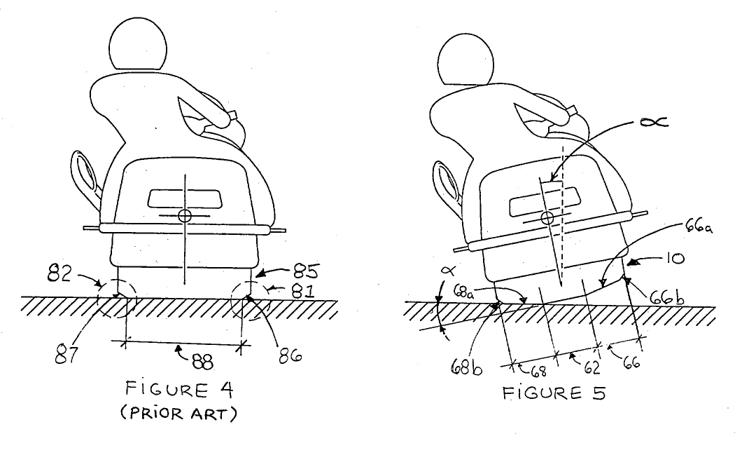

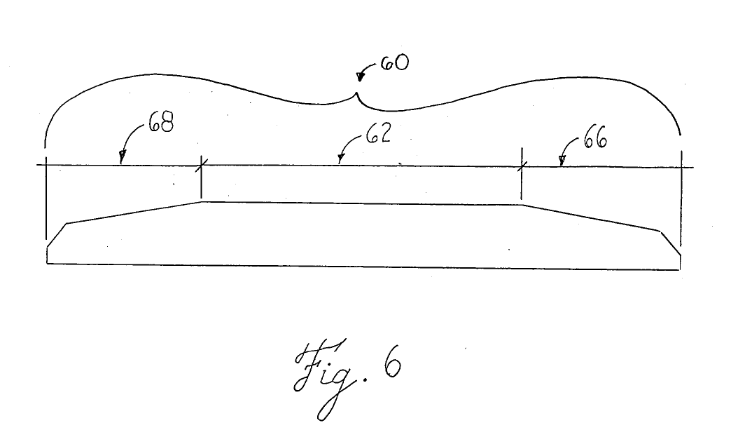

FIG. 5 illustrates the track (10) with tapered exterior sections (66, 68) when it is mounted on a snowmobile and distinguishes it from the track (85) of the prior art shown in FIG. 4. For instance, when the driver wants to turn along a curved path, he/she can offset his/her body weight to enhance the steering capabilities of the snowmobile.

In FIG. 4, a typical track (85) is mounted on the snowmobile. When viewed in a longitudinal direction, the track defines a generally flat section (88) which is in contact with the ground as the track (85) rotates. Angled tip sections (86, 87) are added to provide clearance with the ground. When the snowmobile is turning, the exterior sections (81, 82) are subjected to intense abrasive forces and, to substantial stress concentrations due to the induced bending in the track area where the angled tip sections (86, 87) have been added. These operating conditions often results in the premature wear of the track (85). The generally flat section (88) ensures a stable ride to the snowmobile driver with its high width ratio with respect to the snowmobile's total lateral width.

By shifting the driver/snowmobile center of mass closer to rotation center of the curved path and closer to the ground surface, the driver can balance the centrifugal forces at a higher rotational speed. However, the flat section (88) prevents the driver from significantly offsetting the weight of the snowmobile. Since the driver's weight is usually significantly smaller than the snowmobile's weight, the side offset of the driver's body mass will result in a slight and non-significant movement of the driver/snowmobile center of mass toward the center of rotation. Therefore, the driver's effort to enhance the steering capabilities of the snowmobile will most likely induce slight bending at the extremities of the flat section (88) with non-significant enhanced steering effect.

On the other hand, the track (10) shown in FIG. 5 comprises a generally flat central section (62) which fills the same stability function as the flat section (88) shown in FIG. 4. However, the added tapered exterior sections (66, 68) provide the driver with an inventive capacity to offset the center of mass of the driver/snowmobile assembly closer to the path's center of rotation and closer to the ground, which help balance the centrifugal forces at a higher rotational speed without slipping. The outermost tip subsections (66b, 68b) ensure the same clearance function as the angled tip sections (86, 87) shown in FIG. 4.

Although the ratio of the central section (62) has been reduced with respect to the snowmobile's total lateral width, the track (10) remains laterally stable when traveling in course. Thus, the interior section (62) has to be large enough to adequately support the snowmobile.

As the driver leans on the side and offsets his weight, the innermost main subsection (66a, 68a) of the exterior sections (66, 68) allows the driver to slightly rotate the snowmobile along a longitudinal direction. Since the weight of the snowmobile is significantly larger than the weight of the driver, this added rotational characteristic improves the movement of the driver/snowmobile center of mass closer to the rotation center of the curved path and closer to the ground, such that the steering capabilities of a snowmobile in a curved path are greatly enhanced. The driver can therefore perform turning maneuvers at a higher rotational speed without adding more chance of slipping than a track from the prior art.

Although a preferred embodiment of the invention has been described in detail herein and illustrated in the accompanying figures, it is to be understood that the invention is not limited to this precise embodiment and that various changes and modifications may be effected therein without departing from the scope or spirit of the present invention.

1. An endless track for a vehicle, said track having an endless body being defined by a pair of opposite lateral edges which delimit a body width of said track, by a ground-engaging outer side and by an inner side, said ground-engaging outer side having a tread pattern comprising a plurality of projecting traction lugs having an upper edge which, when viewed along a longitudinal direction, together delimit the outline of a cross-sectional transversal traction lug profile projected above said body, said transversal traction lug profile comprising:
a) a central section, having a central width, and
b) two opposite lateral sections, each located on one side of said central section,
wherein said lateral sections taper from said central section towards said lateral edges of said body and said central width varies from ⅓ to ⅔ of said body width.

2. An endless track, as claimed in claim 1, wherein said central width varies from 40% to 60% of said body width.

3. An endless track, as claimed in claim 1, wherein said central width varies from 45% to 55% of said body width.

4. An endless track, as claimed in claim 1, wherein said central width is approximately 50% of said body width.

5. An endless track, as claimed in claim 1, wherein said central width is approximately 43% of said body width.

6. An endless track, as claimed in claim 1, wherein said lateral sections taper from said central section towards said lateral edges of said body along a straight direction.

7. An endless track, as claimed in claim 1, wherein said lateral sections taper from said central section towards said lateral edges of said body along a curved direction.

8. An endless track, as claimed in claim 1, wherein said lateral sections taper in steps from said central section towards said lateral edges of said body.

9. An endless track for a vehicle, the track having an endless body made of a reinforced rubber material, said body defining a pair of lateral edges, a longitudinally extending central band portion, two support band portions located on each side of and next to said central band portion and two lateral band portions located on each side of said central band portion and next to said support portions, the said body having a ground-engaging outer side and an inner side, the said ground-engaging outer side having a substantially flat core portion and a tread pattern being repeated uniformly or not over the entire length of the track, the said tread pattern comprising a plurality of projecting traction lugs each having an upper edge which together delimit the outline of a cross-sectional transversal traction lug profile which is raised above said flat core portion when viewed along a longitudinal direction, the said transversal traction lug profile comprising:
a) a substantially flat central section having a first side and a second side,
b) a first lateral section adjacent said first side of the said flat central section, and
c) a second lateral section adjacent said second side of the said flat central section,
wherein the portion of the traction lug profile formed by each of said first and second lateral sections tapers towards said flat core portion as it extends from said flat central section towards said lateral edges such that the steering capabilities of said vehicle are enhanced.

10. An endless track according to claim 9, characterized in that said lateral sections of said traction lug profile have an average angle in the range of 10 to 40 degrees with reference to said central section.

11. An endless track according to claim 9, characterized in that said lateral sections of the traction lug profile comprises:
a) an innermost main subsection having an average angle in the range of 10 to 40 degrees with reference to said central section; and
b) an outermost tip subsection having an average angle in the range of 40 to 80 degrees with reference to said central section.

12. An endless track according to claim 9, characterized in that said central section of each said traction lug profile is straight and is generally parallel to the other said traction lug profiles and to said central portion of said body when viewed along its longitudinal axis.

13. An endless track according to claim 9, characterized in that each said lateral section of the traction lug profile is straight and symmetrical with reference to the longitudinal axis of the track.

14. An endless track according to claim 9, characterized in that each said lateral section of the traction lug profile is curved and symmetrical with reference to the longitudinal axis of the track.

15. An endless track according to claim 9, characterized in that said central section of said traction lug profile has a width that is somewhat equal to that of the said central portion and each said lateral section of said traction lug profile has a width that is somewhat equal to that of the corresponding combination of said lateral band portion and said support band portion.

16. An endless track according to claim 9, wherein said central portion extends over said central band portion, over said support band portions but not over said lateral band portions.

17. An endless track according to claim 9, wherein said central portion extends over said central band portion, over said support band portions and partially over said lateral band portions for a distance not exceeding the width of said support band portions.

18. An endless track according to claim 9, characterized in that said vehicle is a snowmobile.

19. An endless track according to claim 10, characterized in that said vehicle is a snowmobile.

20. An endless track according to claim 11, characterized in that said vehicle is a snowmobile.

21. An endless track according to claim 12, characterized in that said vehicle is a snowmobile.

22. An endless track according to claim 14, characterized in that said vehicle is a snowmobile.

23. An endless track according to claim 15, characterized in that said vehicle is a snowmobile.

24. An endless track according to claim 16, characterized in that said vehicle is a snowmobile.

25. An endless track according to claim 17, characterized in that said vehicle is a snowmobile.
